(19) United States
(12) Patent Application Publication
(10) Pub. No.: US 2019/0380532 A1
(43) Pub. Date: Dec. 19, 2019

(54) Cooking Rack

(71) Applicant: Marc Gelati, Plant City, FL (US)

(72) Inventor: Marc Gelati, Plant City, FL (US)

(21) Appl. No.: 16/006,937

(22) Filed: Jun. 13, 2018

(51) Int. Cl. A47J 37/06; A47J 43/18

(52) U.S. Cl. CPC A47J 37/0694; A47J 43/18

(57) ABSTRACT

A cooking rack for suspending chicken legs includes a plate and a pair of end members. Each end member is coupled to a bottom of the plate proximate to a respective opposing end of the plate. The end members extend substantially perpendicularly from the plate and are configured to support the plate substantially parallel to a surface. Each of a plurality of slots extends into the plate from a respective opposing edge of the plate. The plurality of slots defines a plurality of tabs. Each slot is configured to insert a respective food item to couple the food item to the plate and positioning the food item substantially perpendicularly to the surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to racks and more particularly pertains to a new rack for suspending chicken legs.

### BRIEF SUMMARY OF THE INVENTION

An embodiment of the disclosure meets the needs presented above by generally comprising a plate and a pair of end members. Each end member is coupled to a bottom of the plate proximate to a respective opposing end of the plate. The end members extend substantially perpendicularly from the plate and are configured to support the plate substantially parallel to a surface. Each of a plurality of slots extends into the plate from a respective opposing edge of the plate. The plurality of slots defines a plurality of tabs. Each slot is configured to insert a respective food item to couple the food item to the plate and positioning the food item substantially perpendicularly to the surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a cooking rack according to an embodiment of the disclosure.

FIG. 2 is a bottom view of an embodiment of the disclosure.

FIG. 3 is a side view of an embodiment of the disclosure.

FIG. 4 is a top view of an embodiment of the disclosure.

FIG. 5 is an in-use view of an embodiment of the disclosure.

### DETAILED DESCRIPTION OF THE INVENTION

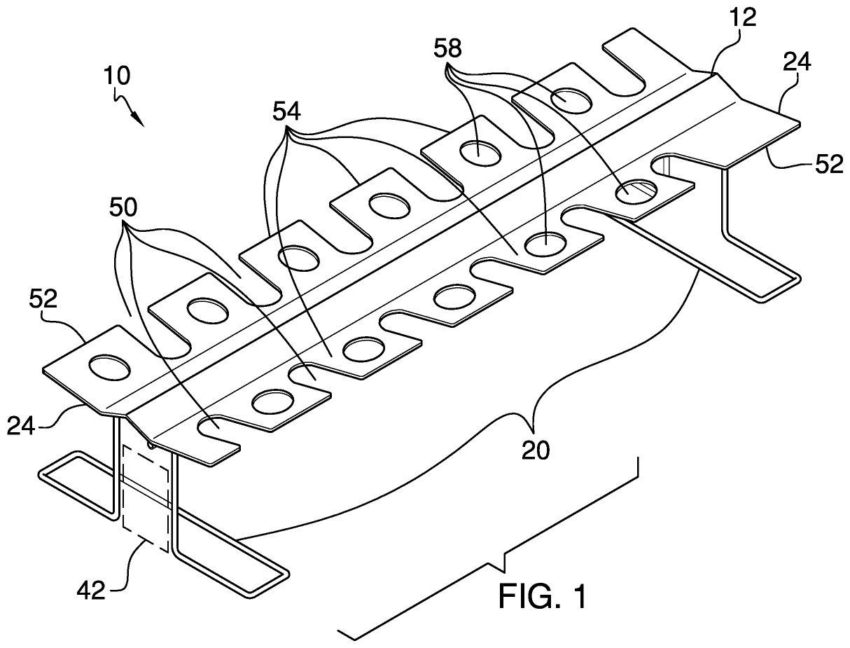

With reference now to the drawings, and in particular to FIGS. 1 through 5 thereof, a new rack embodying the principles and concepts of an embodiment of the disclosure and generally designated by the reference numeral 10 will be described.

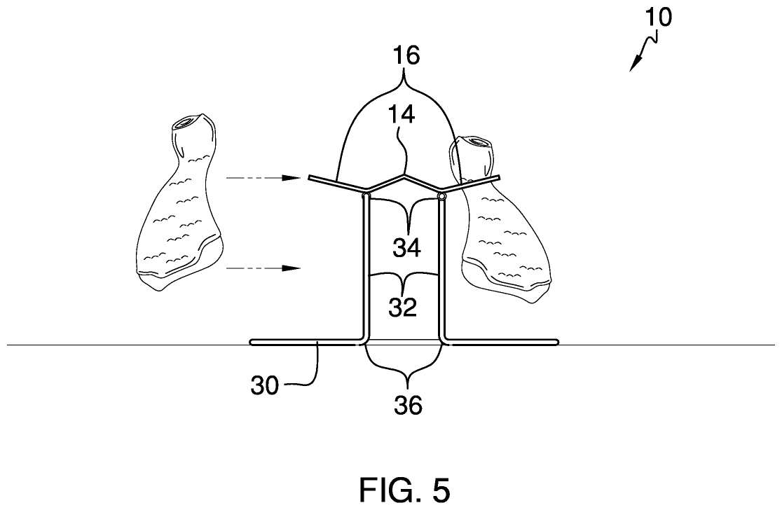

As best illustrated in FIGS. 1 through 5, the cooking rack 10 generally comprises a plate 12. The plate 12 comprises metal, such as stainless steel or the like. The plate 12 comprises a first section 14 and a pair of second sections 16. The first section 14 is V-shaped when viewed longitudinally. Each second section 16 is coupled to and extends transversely from a respective opposing side edge 18 of the first section 14 so that the plate 12 is flattened W-shaped when viewed longitudinally, as shown in FIG. 5.

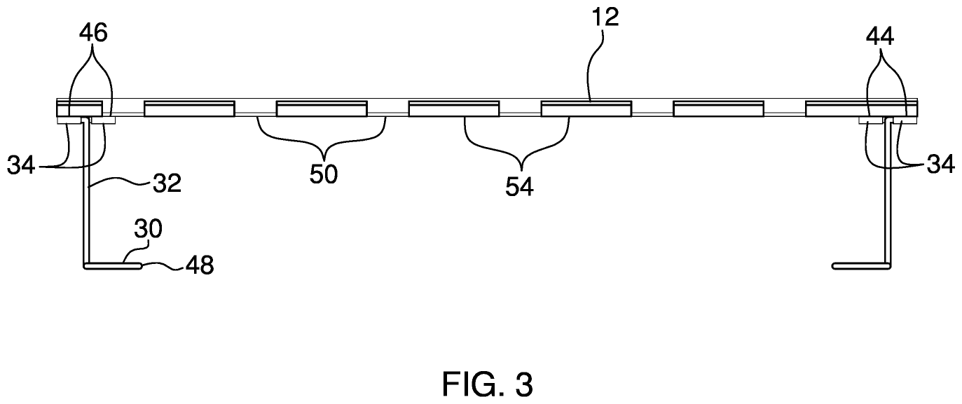

Each of a pair of end members 20 is coupled to a bottom 22 of the plate 12 proximate to a respective opposing end 24 of the plate 12, as shown in FIG. 3. The end members 20 extend substantially perpendicularly from the plate 12. The end members 20 are configured to support the plate 12 substantially parallel to a surface. The end members 20 are removably coupled to the plate 12 to allow for disassembly, cleaning, and storage.

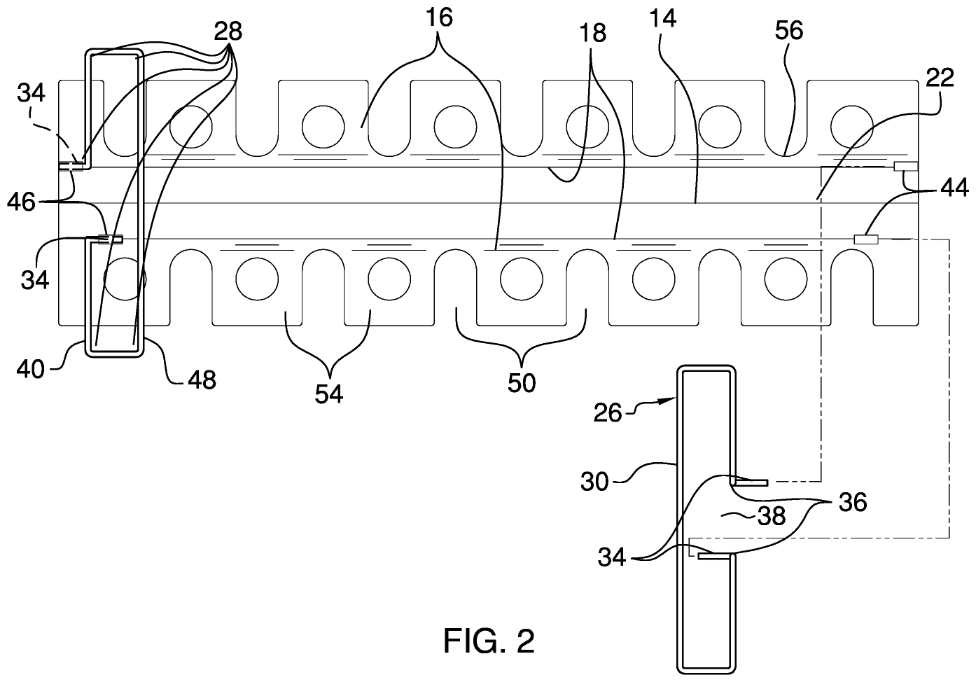

Each end member 20 comprises a rod 26 that has a plurality of right-angled bends 28, as shown in FIGS. 1 and 2. The right-angled bends 28 define a base section 30, a pair of vertical sections 32, and a pair of couplers 34. The base section 30 is rectangularly shaped and has opposing endpoints 36 that define an opening 38 that is positioned in a first edge 40 of the base section 30. Each vertical section 32 extends from a respective opposing endpoint 36 of the base section 30 so that the vertical sections 32 are perpendicular to the base section 30. Each coupler 34 extends from a respective vertical section 32 distal from the base section 30. The couplers 34 extend perpendicularly to and in opposing directions relative to a plane 42 defined by the pair of vertical sections 32.

A pair of first tubes 44 is coupled to the bottom 22 of the plate 12, as shown in FIG. 2. The pair of first tubes 44 is positioned proximate to one opposing end 24 of the plate 12. The vertical sections 32 of one end member 20 are configured to be flexed in hands of a user to position the couplers 34 of the one end member 20 to be inserted into the pair of first tubes 44 to couple the one end member 20 to the plate 12.

A pair of second tubes 46 is coupled to the bottom 22 of the plate 12, as shown in FIG. 2. The pair of second tubes 46 is positioned proximate to the other opposing end 24 of the plate 12. The vertical sections 32 of the other end member 20 are configured to be flexed in the hands of the user to position the couplers 34 of the other end member 20 to be inserted into the pair of second tubes 46 to couple the other end member 20 to the plate 12. Each end member 20 is couplable to the plate 12 so that a second edge 48 of the base section 30 extends below the bottom 22 of the plate 12.

One first tube 44 and one second tube 46 are positioned on one opposing side edge 18 of the first section 14 of the plate 12. The one first tube 44 and the one second tube 46 are positioned singly adjacent to each opposing end 24 of the plate 12. The other first tube 44 and the other second tube 46 are positioned on the other opposing side edge 18 of the first section 14 of the plate 12. The other first tube 44 and the other second tube 46 are positioned singly proximate to each opposing end 24 of the plate 12.

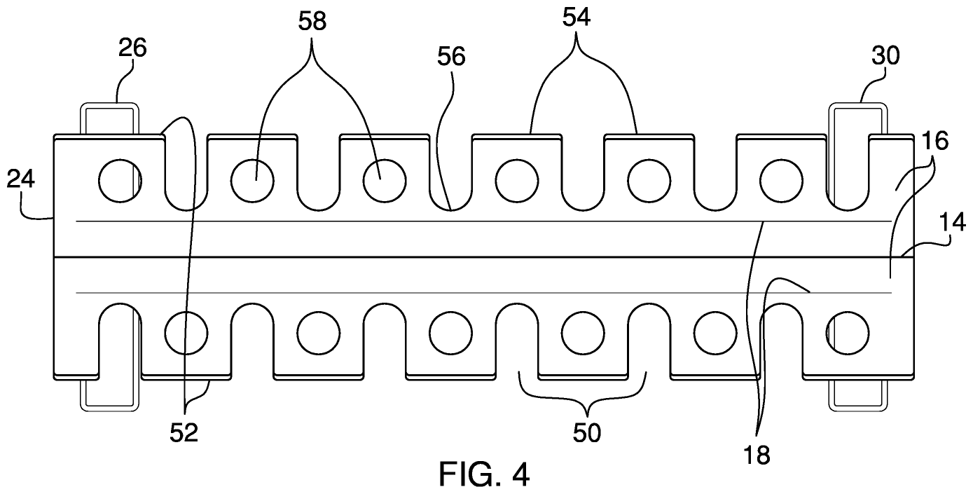

Each of a plurality of slots 50 extends into the plate 12 from a respective opposing edge 52 of the plate 12, as shown in FIG. 4. The plurality of slots 50 defines a plurality of tabs 54. Each slot 50 is configured to insert a respective food item, such as a chicken leg, to couple the food item to the plate 12 and to position the food item substantially perpendicularly to the surface. The cooking rack 10 and the food item are configured to be positioned in an oven, grill, or the like, to cook the food item.

The slots 50 that are positioned in one opposing edge 52 are offset from the slots 50 that are positioned in the other opposing edge 52 so that the slots 50 that are positioned in the one opposing edge 52 are each aligned with an associated tab 54 that is positioned on the other opposing edge 52. The configuration staggers chicken legs that are positioned in the slots 50 the one opposing edge 52 relative to chicken legs that are positioned in the slots 50 of the other opposing edge 52 to evenly cook the chicken legs.

The plurality of slots 50 comprises from eight to sixteen slots 50. The plurality of slots 50 comprises twelve slots 50 that are positioned six-apiece in each opposing edge 52 of the plate 12. Each slot 50 has a terminus 56 distal from the respective opposing edge 52. The terminus 56 is arcuate to complement the contour of the chicken leg.

Each of a plurality of holes 58 is positioned in a respective tab 54, as shown in FIG. 4. The holes 58 are circularly shaped. Each hole 58 is configured to insert sauce so that the sauce is applied to the respective food item. This configuration allows the sauce to be applied to otherwise difficult to reach surfaces of the chicken legs.

In use, the end members 20 are coupled to the plate 12. The chicken legs are inserted singly into the slots 50. The cooking rack 10 and the chicken legs are positioned in the oven or grill to cook the chicken legs. As desired, the sauce can be applied to the hard to reach surfaces of the chick legs through the holes 58. Upon completion, the end members 20 can be removed from the plate 12 to clean and store the cooking rack 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cooking rack comprising:
a plate;
a pair of end members, each end member being coupled to a bottom of the plate proximate to a respective opposing end of the plate, the end members extending substantially perpendicularly from the plate wherein the end members are configured for supporting the plate substantially parallel to a surface; and
a plurality of slots, each slot extending into the plate from a respective opposing edge of the plate such that the plurality of slots defines a plurality of tabs wherein each slot is configured for inserting a respective food item for coupling the food item to the plate positioning the food item substantially perpendicularly to the surface.

2. The rack of claim 1, further including the plate comprising metal.

3. The rack of claim 2, further including the plate comprising stainless steel.

4. The rack of claim 1, further including the plate comprising a first section and a pair of second sections, the first section being V-shaped when viewed longitudinally, each second section being coupled to and extending transversely from a respective opposing side edge of the first section such that the plate is flattened W-shaped when viewed longitudinally.

5. The rack of claim 1, further including the end members being removably coupled to the plate.

6. The rack of claim 4, further comprising:
each end member comprising a rod having a plurality of right-angled bends defining a base section, a pair of vertical sections, and a pair of couplers, the base section being rectangularly shaped with an opening defined by opposing endpoints of the base section, the opening being positioned in a first edge of the base section, each vertical section extending from a respective opposing endpoint of the base section such that the vertical sections are perpendicular to the base section, each coupler extending from a respective vertical section distal from the base section, the couplers extending perpendicularly to and in opposing directions relative to a plane defined by the pair of vertical sections;
a pair of first tubes coupled to the bottom of the plate, the pair of first tubes being positioned proximate to one opposing end of the plate wherein the vertical sections of one end member are configured for flexing in hands of a user for positioning the couplers of the one end member for inserting into the pair of first tubes for coupling the one end member to the plate; and
a pair of second tubes coupled to the bottom of the plate, the pair of second tubes being positioned proximate to the other opposing end of the plate wherein the vertical sections of the other end member are configured for flexing in the hands of the user for positioning the couplers of the other end member for inserting into the pair of second tubes for coupling the other end member to the plate.

7. The rack of claim 6, further including each end member being couplable to the plate such that a second edge of the base section extends below the bottom of the plate.

8. The rack of claim 6, further including one first tube and one second tube being positioned on one opposing side edge of the first section of the plate such that the one first tube and the one second tube are positioned singly adjacent to each opposing end of the plate, the other first tube and the other second tube being positioned on the other opposing side edge of the first section of the plate such that the other first tube and the other second tube are positioned singly proximate to each opposing end of the plate.

9. The rack of claim 1, further including the slots positioned in one opposing edge being offset from the slots positioned in the other opposing edge such that the slots positioned in the one opposing edge are each aligned with an associated tab positioned on the other opposing edge.

10. The rack of claim 1, further including the plurality of slots comprising from eight to sixteen slots.

11. The rack of claim 10, further including the plurality of slots comprising twelve slots positioned six-apiece in each opposing edge of the plate.

12. The rack of claim 1, further including each slot having a terminus distal from the respective opposing edge, the terminus being arcuate.

13. The rack of claim 1, further including a plurality of holes, each hole being positioned in a respective tab wherein the hole is configured for inserting sauce such that the sauce is applied to the respective food item.

14. The rack of claim 13, further including the holes being circularly shaped.

15. A cooking rack comprising:
a plate, the plate comprising metal, the plate comprising stainless steel, the plate comprising a first section and a pair of second sections, the first section being V-shaped when viewed longitudinally, each second section being coupled to and extending transversely from a respective opposing side edge of the first section such that the plate is flattened W-shaped when viewed longitudinally;
a pair of end members, each end member being coupled to a bottom of the plate proximate to a respective opposing end of the plate, the end members extending substantially perpendicularly from the plate wherein the end members are configured for supporting the plate substantially parallel to a surface, the end members being removably coupled to the plate, each end member comprising a rod having a plurality of right-angled bends defining a base section, a pair of vertical sections, and a pair of couplers, the base section being rectangularly shaped with an opening defined by opposing endpoints of the base section, the opening being positioned in a first edge of the base section, each vertical section extending from a respective opposing endpoint of the base section such that the vertical sections are perpendicular to the base section, each coupler extending from a respective vertical section distal from the base section, the couplers extending perpendicularly to and in opposing directions relative to a plane defined by the pair of vertical sections;
a pair of first tubes coupled to the bottom of the plate, the pair of first tubes being positioned proximate to one opposing end of the plate wherein the vertical sections of one end member are configured for flexing in hands of a user for positioning the couplers of the one end member for inserting into the pair of first tubes for coupling the one end member to the plate;
a pair of second tubes coupled to the bottom of the plate, the pair of second tubes being positioned proximate to the other opposing end of the plate wherein the vertical sections of the other end member are configured for flexing in the hands of the user for positioning the couplers of the other end member for inserting into the pair of second tubes for coupling the other end member to the plate, each end member being couplable to the plate such that a second edge of the base section extends below the bottom of the plate, one first tube and one second tube being positioned on one opposing side edge of the first section of the plate such that the one first tube and the one second tube are positioned singly adjacent to each opposing end of the plate, the other first tube and the other second tube being positioned on the other opposing side edge of the first section of the plate such that the other first tube and the other second tube are positioned singly proximate to each opposing end of the plate;
a plurality of slots, each slot extending into the plate from a respective opposing edge of the plate such that the plurality of slots defines a plurality of tabs wherein each slot is configured for inserting a respective food item for coupling the food item to the plate positioning the food item substantially perpendicularly to the surface, the slots positioned in one opposing edge being offset from the slots positioned in the other opposing edge such that the slots positioned in the one opposing edge are each aligned with an associated tab positioned on the other opposing edge, the plurality of slots comprising from eight to sixteen slots, the plurality of slots comprising twelve slots positioned six-apiece in each opposing edge of the plate, each slot having a terminus distal from the respective opposing edge, the terminus being arcuate; and
a plurality of holes, each hole being positioned in a respective tab wherein the hole is configured for inserting sauce such that the sauce is applied to the respective food item, the holes being circularly shaped.
